(19) United States
(12) Patent Application Publication
(10) Pub. No.: US 2007/0009121 A1
(43) Pub. Date: Jan. 11, 2007

(54) Method for processing the signals from two or more microphones in a listening device and listening device with plural microphones

(76) Inventor: Kim S. Petersen, Smorum (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/574,926

(22) PCT Filed: Sep. 16, 2004
(86) PCT No.: PCT/DK04/00614

§ 371 Date: Jun. 21, 2006

(30) Foreign Application Priority Data
Oct. 10, 2003 (DK) PA2003 05102

(51) Int. Cl. H04R 25/00

(52) U.S. Cl. 381/312

(57) ABSTRACT

A method for processing the signals from two or more microphones in a listening device, and a listening device for conducting the method which has a casing holding the microphones, a signal processing unit which provides an output signal corresponding to the microphone signals and suited to the user's hearing, and a receiver unit for delivering the output signal to the user whereby the signals from the microphones are analyzed in order to detect when the casing of the listening device is being touched, whereby further the signal processing of the signal processing unit changes whenever touching of the casing is detected.

### AREA OF THE INVENTION

The invention relates to listening devices such as hearing aids and in particular to listening devices having a casing and an array of microphones comprising two or more microphones, a signal processing device, and a receiver for delivering an output to the user of the listening device. Such devices encompass hearing aids and headsets and various other assistive listening devices.

### BACKGROUND OF THE INVENTION

In listening devices of this kind it is a problem that the microphones need to be closely matched in order for a possible directional computational algorithms to function optimally. In order that the microphone stay matched over a long period, an automatic matching process is introduced. Here the signals from the microphones are continually analysed to ensure that over time there is no big difference in the output level from the microphones. In such listening devices it is also a problem, that when the casing is accidentally touched or touched when applied to the ear, very loud sound output levels may be produced as the microphones are very sensitive to noise propagated through the material of the casing walls.

If substantial differences in the input to the microphones should occur, this might corrupt the outcome of the automatic matching process. Further it has been discovered that such large differences are most likely to coincide with the occurrence of large and unpleasant noises which the user would prefer not to hear lice the noise which is produced when the casing is touched by the user. In hearing aids a large gain or amplification of the audio signal is introduced to compensate for the hearing loss of the user. This amplification amplifies all signals, wanted as well as non-wanted. The wanted signals usually originates some distance from the hearing aid and arrives travelling through the air. Noise from touching the hearing aid is very unpleasant since it results in a loud output signal from the hearing aid because of the frictional resistance, the banging from the acceleration of fingers ect. The noise increases as the origin of the noise moves closer to one of the microphones in a multi-microphone hearing aid.

### SUMMARY OF THE INVENTION

To overcome to above problem the inventions provides a method for processing the signals from two or more microphones in a listening device whereby the signals from the microphones are analysed in order to detect when the casing is touched, whereby changes in the signal processing are effected whenever touching of the casing is detected.

According to the invention, the time dependent differences in short term energy in the signals from the microphones is determined. This time related change may in itself provide information as to possible touching of the hearing aid casing, and also it may be further analysed to detect the occurrence of something or somebody touching the hearing aid casing with a higher degree of certainty.

Preferably the time related change in difference in the short term energy content in the microphone signals is used to determine the rate of change in difference between the short term energy of the microphone signals. Here touching noise will change the difference in measured energy between the two microphones very fast compared to other signals received by the microphones. Noise generated by wind will also change the input, but since it originates from turbulence, the mean energy level from the two microphones will not change fast because of the uncorrelated nature of the wind noise. Other ways of detecting touching noise are possible, but the short term energy differences are easily detected and it is easy to determine a reliable threshold where the signal processing should react to compensate for the loud noise. The threshold my comprise both a threshold for the absolute value of the difference in short term energy and a threshold for the rate of change of the difference in short term energy.

In an embodiment of the invention, the changes in the signal processing which are effected whenever touching of the casing is detected comprises short term muting or attenuation of the output signal in order to protect the user from the annoyance of the loud sounds caused by the touching of the casing.

In yet another embodiment of the invention, the changes in the signal processing which are effected whenever touching of the casing is detected comprises a time limited shut down of an automatic microphone matching process. In this way it is ensured, that the matching process is not disturbed by the large short term differences in the energy contents of the signal from the microphones.

In a further embodiment of the invention, the changes in the signal processing which are effected whenever touching of the casing is detected comprises lasting changes in the processing of the audio signal presented to the user of the listening device. Such changes could be program shifts, volume op or down or permanent muting of the listening device according to the wishes of the user.

### BRIEF DESCRIPTION OF THE DRAWINGS

FIG. 1 shows the diagram of a detector to detect touch noise,

FIG. 2 shows the time related difference in short term energy content in two microphone channels where the sound level in the environment is low,

FIG. 3 shows the time related differences in short term energy content in two microphone channels where the sound level in the environment is high,

FIG. 4 shows the time related difference in short term energy content in two microphone channels whereby two distinct detections of touching events are made within a given time.

### DESCRIPTION OF A PREFERRED EMBODIMENT

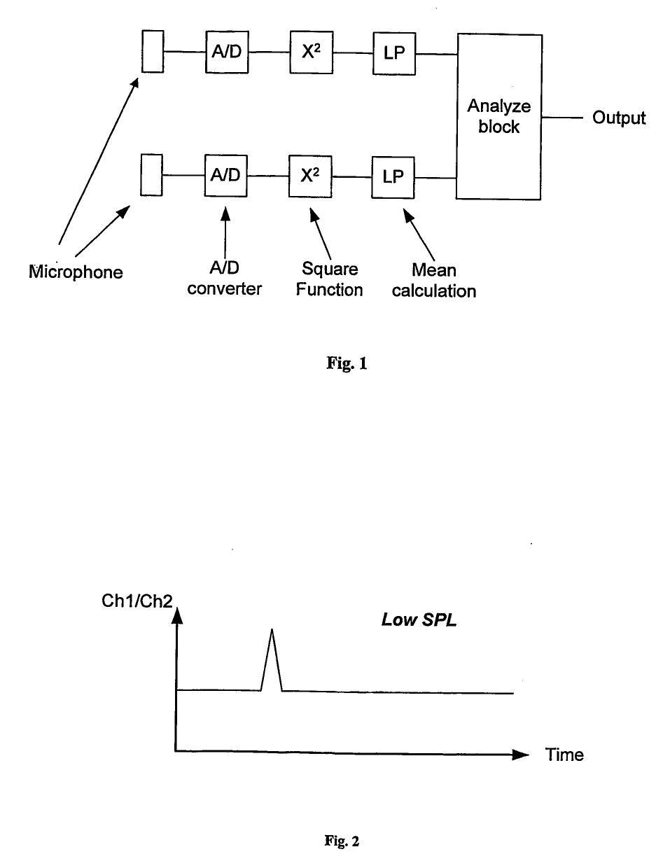

FIG. 1 shows one way to detect touching noise. Two microphones are provided which transform acoustical signals to analog electric signals. The analog signals are transformed into the digital domain in analog to digital converters. The signals are then transferred to a DSP unit or similar signal processing element. In the DSP unit the digital signal is treated in order to determine whether the signal from the microphones originates from the surroundings or is caused by something touching the shell of the hearing aid.

Initially a mean value of the energy in each of the two channels is calculated. One way to detect whether a signal originates from a touching noise is to analyse the difference or ratio between the energies in the two channels. If the ratio makes a fast shift, this is an indication that the signal originates from touching noise. When the presence of such a signal is determined a value within the DSP is shifted, and other parts of the DSP unit may react to the shift of this value. One reaction could be to stop the automatic procedure for amplitude and/or phase matching of the two microphones. In this way it is assured, that the microphone matching procedure is not influenced by the large differences in amplitude and/or phase which will occur when the hearing aid shell is touches. This may be extended such that the time pattern of the ratio between the two signals is determined for a given length of time. By doing this it becomes possible to determine the occurrence of repeated touching of the hearing aid. This could be used for communication of user input to the hearing aid. An example of user input could be program shifts or control of the volume.

In a further embodiment of the invention the sign of the difference between the energies or the size of the ratio is calculated, whereby it is possible to determine whether the hearing aid casing is touched near the one or near the other microphone opening. This can be used to distinguish between at least two different user inputs to the hearing aid.

As seen in FIG. 1, a measure for the energy content of the signal in the two microphone channels is obtained by calculating the square of the signal value. Hereafter a mean value calculator is provided which will smooth the signal and dispense with very short term changes and further a down sampling of the microphone signals can be achieved, such that the power for the calculations is diminished. In the signal analyse block the difference or ratio between the energy of the microphone signals is determined, and the temporal changes in this value is analysed.

At the casing a sound generating element can be arranged, which when touched provides a well defined sound impulse to the casing. This sound impulse may be detected through the analyses of the signal from the microphones. In this way the user can interact with the listening device through the microphones of the device in a secure manner. The advantage here is that the listening device can be made without an elctro-mechanical button which is otherwise usual. The absence of the electro-mehanical button is advantageous as the electrical connection thereof to the signal processing device then becomes superfluous.

The analyse block determines whether the signal from the microphone originates from touching the casing or from a soundsource in the environment. The input to the analyse block is an estimate of the power in each channel. On FIG. 2 the time related ratio between the two microphone channels is shown, whereby the vertical axis is the ratio: Ch1/Ch2 and the horizontal axis is time. If the signal is a normal acoustic signal, then the ratio is constant over a short-term period, and this is shown as the horizontal line in the graph. If the environment is relatively quiet the noise from touching the microphone in channel 1 results in the ratio shown in FIG. 2. The peak in FIG. 2 originates from noise generated by touching of the casing material whereby a sudden change in the ratio between the energy contents in the two channels will occur which is registered by the analyse block. If the rate of change is above a given threshold and at the same time the size of the value of Ch1/Ch2 is above a given threshold, it is determined that the hearing aid casing is touched.

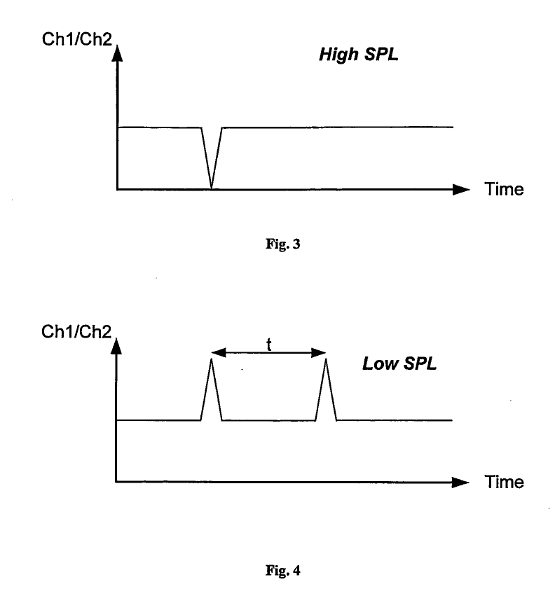

If the environment is not quiet the touching and possible closing or covering of the microphone channel results in an attenuation of the incoming signal. The ratio between the two channels in this case is as shown in FIG. 3. This is useful in the event, where the user is to communicate with the hearing aid in an environment with very loud sound pressure. Here the microphones may be saturated and any additional sound, such as might be generated by touching the shell cannot be detected whereas the sudden absence of sound in one channel is easily detected as a sudden change of the value Ch1/Ch2 and can be acted upon.

The analyse block can then extend this functionality to both microphones, so that the system reacts differently depending on which microphone the touching noise is centred.

Another possibility is to measure the time between the touching of the inlets. The device could react differently if the inlets are touched more than ones in a specified time. This feature is showed in FIG. 4. By this possibility the user may be given the possibility to communicate with the hearing aid and have different actions like volume up, volume down or program changes effected.

1. Method for processing the signals from two or more microphones in a listening device which has a casing holding the microphones, and which further comprises a signal processing unit which is to provide an output signal in correspondence with the microphone signals and suited to the users hearing whereby a receiver unit for delivering the output signal to the user is provided, whereby the signals from the microphones are analysed in order to detect when the casing of the listening device is being touched, whereby further the signal processing of the signal processing unit changes whenever touching of the casing is detected.

2. Method as claimed in claim 1, whereby the short term energy in the signals from the microphones is determined, and where further the change in difference over time in the short term energy between the microphone signals is determined.

3. Method as claimed in claim 2, whereby the time related change in difference in the short term energy content in the microphone signals is used to determine the rate of change in difference between the short term energy of the microphone signals.

4. Method as claimed in claim 2, whereby a value in the signal processing unit is changed whenever the rate of change in difference in the short term energy between the microphone signals reaches a pre-selected level in order to indicate that the casing is being touched.

5. Method as claimed in claim 3, whereby a microphone matching procedure is temporarily interrupted whenever it is determined that the casing is being touched.

6. Method as claimed in claim 3, whereby the output signal to the user is temporarily attenuated whenever it is determined that the casing is being touched.

7. Method as claimed in claim 3, whereby a lasting change in the signal processing is effected whenever it is determined that a non-accidental touch of the casing has occurred.

8. Listening device having two or more microphones and comprising a casing holding the microphones and a signal processing unit which is to provide an output signal in correspondence with the microphone signal and suited to the users hearing whereby further a receiver unit for delivering the output signal to the user is provided, whereby analysing means are provided for analysing the signals from the microphones in order to detect when the hearing aid casing is touched, whereby further means are provide for changing the signal processing of the listening device whenever touching of the casing of the listening device is detected.

9. Listening device as claimed in claim 7, whereby a sound generator for generating a specific sound when touched is provide at the casing, such that the user may touch the sound generator whenever a user input to the hearing aid is desirable.
